(19) United States
(12) Patent Application Publication
(10) Pub. No.: US 2017/0067386 A1
(43) Pub. Date: Mar. 9, 2017

(54) EXHAUST GAS PURIFICATION DEVICE FOR INTERNAL COMBUSTION ENGINE

(71) Applicant: DENSO CORPORATION, Kariya-city, Aichi-pref. (JP)

(72) Inventor: Yasuhiro Kawakatsu, Kariya-city (JP)

(21) Appl. No.: 15/308,972

(22) PCT Filed: Apr. 17, 2015
(86) PCT No.: PCT/JP2015/002122

§ 371 Date: Nov. 4, 2016

(30) Foreign Application Priority Data
May 6, 2014 (JP) 2014-95617

(51) Int. Cl. F01N 11/00; F02D 41/14; F02D 41/30; F01N 3/20

(52) U.S. Cl. CPC F01N 11/007; F01N 3/20; F02D 41/1458; F02D 41/3005; F01N 2550/02

(57) ABSTRACT

An oxygen storage state of a catalyst is estimated based on an output of an air-fuel ratio sensor, and the oxygen storage state of the catalyst is controlled, such that the oxygen storage state of the catalyst reaches a neutral state, based on an estimation value of the oxygen storage state. In addition, the estimation value of the oxygen storage state is corrected based on the estimation value of the oxygen storage state and an output of an oxygen sensor such that deterioration of accuracy of the oxygen storage state estimation is restricted. Furthermore, a constant current is caused to flow in a direction in which rich detection by the oxygen sensor is expedited in a case of transition of the output of the oxygen sensor to a lean side. The constant current is caused to flow in a direction in which lean detection by the oxygen sensor is expedited in a case of transition of the output of the oxygen sensor to a rich side. Accordingly, an air-fuel ratio change in the catalyst and a change in actual oxygen storage state of the catalyst can be detected early based on the output of the oxygen sensor, and the deterioration of the accuracy of the oxygen storage state estimation can be detected early.

### CROSS REFERENCE TO RELATED APPLICATION

This application is based on Japanese Patent Application No. 2014-95617 filed on May 6, 2014, the disclosure of which is incorporated herein by reference.

### TECHNICAL FIELD

The present disclosure is an invention relating to an exhaust gas purification device for an internal combustion engine in which exhaust gas sensors that detect an air-fuel ratio of exhaust gas are installed on an upstream side and a downstream side of an internal combustion engine exhaust gas purification catalyst.

### BACKGROUND ART

In an exhaust gas purification system for an internal combustion engine, an exhaust gas sensor (air-fuel ratio sensor or oxygen sensor) that detects an air-fuel ratio of exhaust gas is installed on each of an upstream side and a downstream side of an exhaust gas purification catalyst so that an exhaust gas purification rate of the exhaust gas purification catalyst is raised. “Main feedback control”, which is feedback correction of a fuel injection quantity based on an output of the exhaust gas sensor on the upstream side, is performed so that the air-fuel ratio of the exhaust gas on the upstream side of the catalyst becomes an upstream side target air-fuel ratio. In addition, “sub-feedback control”, which is correction of the target air-fuel ratio of the main feedback control or modification of a feedback correction amount or the fuel injection quantity of the main feedback control based on an output of the exhaust gas sensor on the downstream side, is performed so that the air-fuel ratio of the exhaust gas on the downstream side of the catalyst becomes a downstream side target air-fuel ratio.

The exhaust gas sensor such as the oxygen sensor has a sensor output change delay with respect to a change in actual air-fuel ratio when the air-fuel ratio of the exhaust gas changes.

In some systems in which the sub-feedback control is performed based on an output of a downstream-side exhaust gas sensor, an output characteristic of the downstream-side exhaust gas sensor can be changed, as described in Patent Literature (JP 2013-170453 A), by a constant current circuit disposed outside the downstream-side exhaust gas sensor causing a constant current to flow between sensor electrodes. This allows the air-fuel ratio in the catalyst becoming lean with respect to purification window to be detected early by the downstream-side exhaust gas sensor, by the constant current flowing in a direction in which lean detection by the downstream-side exhaust gas sensor is expedited, in a case where the correction resulting from the sub-feedback control is a lean direction. In a case where the correction resulting from the sub-feedback control is a rich direction, this allows the air-fuel ratio in the catalyst becoming rich with respect to the purification window to be detected early by the downstream-side exhaust gas sensor by the constant current flowing in a direction in which rich detection by the downstream-side exhaust gas sensor is expedited. In this manner, the direction of the correction by the sub-feedback control can be switched before a purification performance of the catalyst declines or when the purification performance of the catalyst begins to decline. Accordingly, a period during which a state where the purification performance of the catalyst is high can be maintained (period during which the air-fuel ratio in the catalyst can be maintained in the purification window) can be lengthened and exhaust emission can be reduced.

Nevertheless, a delay that is attributable to a catalyst reaction is present between a change in the air-fuel ratio on the upstream side of the catalyst and a change in the air-fuel ratio in the catalyst, and thus it cannot be said that the control has been carried out at a maximum speed possible. A case where an oxygen storage state of the catalyst is a neutral state is a state where an ability to maintain the air-fuel ratio in the catalyst in the purification window is maximized (that is, a state where robustness is high with respect to air-fuel ratio fluctuation on the upstream side of the catalyst). Accordingly, it is conceivable that promptness and high robustness can be achieved at the same time by the oxygen storage state of the catalyst being estimated based on the air-fuel ratio on the upstream side of the catalyst and the oxygen storage state of the catalyst being controlled based on an estimation value of the oxygen storage state of the catalyst such that the neutral state is maintained as the oxygen storage state of the catalyst.

During the estimation of the oxygen storage state of the catalyst based on the air-fuel ratio on the upstream side of the catalyst, an oxygen storage state estimation error might be caused by variation and fluctuation in catalyst characteristics and the estimation error might deteriorate the accuracy of the estimation. When a state where the oxygen storage state estimation accuracy is deteriorated continues, the actual oxygen storage state of the catalyst cannot be maintained in the neutral state and the exhaust emission cannot be sufficiently reduced in some cases.

### PRIOR ART LITERATURES

### Patent Literature

Patent Literature 1: JP 2013-170453 A

### SUMMARY OF INVENTION

It is an object of the present disclosure is to provide an exhaust gas purification device for an internal combustion engine that is capable of restricting deterioration of accuracy of estimation of an oxygen storage state of a catalyst in a prompt manner.

According to an aspect of the present disclosure, an exhaust gas purification device is provided with an exhaust gas purification catalyst for an internal combustion engine, an upstream-side exhaust gas sensor and a downstream-side exhaust gas sensor respectively detecting an air-fuel ratio of exhaust gas on an upstream side and a downstream side of this catalyst, and a constant current supply unit changing an output characteristic of the downstream-side exhaust gas sensor by causing a constant current to flow between sensor electrodes of the downstream-side exhaust gas sensor. In addition, the exhaust gas purification device includes an estimation unit estimating an oxygen storage state of the catalyst based on an output of the upstream-side exhaust gas sensor, an estimation value correction unit determining accuracy of the oxygen storage state estimation based on an estimation value of the oxygen storage state and an output of the downstream-side exhaust gas sensor and correcting the estimation value of the oxygen storage state such that deterioration of the accuracy of the estimation is restricted, and a sensor output characteristic control unit. The sensor output characteristic control unit controls the constant current supply unit such that the constant current flows in a direction in which rich detection by the downstream-side exhaust gas sensor is expedited in a case of transition of the output of the downstream-side exhaust gas sensor to a lean side from a rich side with respect to a stoichiometric air-fuel ratio equivalent output. The sensor output characteristic control unit controls the constant current supply unit such that the constant current flows in a direction in which lean detection by the downstream-side exhaust gas sensor is expedited in a case of transition of the output of the downstream-side exhaust gas sensor to the rich side from the lean side with respect to the stoichiometric air-fuel ratio equivalent output.

In this configuration, the constant current flows in the direction in which the rich detection by the downstream-side exhaust gas sensor is expedited in the case of the transition of the output of the downstream-side exhaust gas sensor to the lean side from the rich side with respect to the stoichiometric air-fuel ratio equivalent output, and thus a lean-to-rich air-fuel ratio change in the catalyst can be detected early by the downstream-side exhaust gas sensor. The constant current flows in the direction in which the lean detection by the downstream-side exhaust gas sensor is expedited in the case of the transition of the output of the downstream-side exhaust gas sensor to the rich side from the lean side with respect to the stoichiometric air-fuel ratio equivalent output, and thus a rich-to-lean air-fuel ratio change in the catalyst can be detected early by the downstream-side exhaust gas sensor.

An air-fuel ratio change in the catalyst (that is, a change in actual oxygen storage state of the catalyst) can be detected early based on the output of the downstream-side exhaust gas sensor by the output characteristic of the downstream-side exhaust gas sensor being changed as described above. Accordingly, deterioration of the oxygen storage state estimation accuracy can be detected early. As a result, deterioration of the accuracy of the estimation of the oxygen storage state of the catalyst can be promptly restricted by the estimation value of the oxygen storage state being corrected early such that the deterioration of the accuracy of the estimation of the oxygen storage state of the catalyst is restricted.

### BRIEF DESCRIPTION OF DRAWINGS

FIG. 1 is a diagram illustrating a schematic configuration of an engine control system according to an example of the present disclosure.

FIG. 2 is a cross-sectional view illustrating a configuration of a sensor element.

FIG. 3 is an electromotive force characteristic diagram illustrating a relationship between an air-fuel ratio (excess air ratio λ) of exhaust gas and an electromotive force of the sensor element.

FIG. 4A is a schematic diagram illustrating a state of gas components around the sensor element.

FIG. 4B is a schematic diagram illustrating a state of the gas components around the sensor element.

FIG. 5 is a time chart showing a behavior of a sensor output.

FIG. 6A is a schematic diagram illustrating a state of the gas components around the sensor element.

FIG. 6B is a schematic diagram illustrating a state of the gas components around the sensor element.

FIG. 7 is an oxygen sensor output characteristic diagram in the case of increased lean responsiveness/rich responsiveness.

FIG. 8 is a time chart illustrating an execution example of sensor output characteristic control.

FIG. 9 is a time chart illustrating another execution example of the sensor output characteristic control.

FIG. 10 is a flowchart illustrating a flow of processing of an oxygen storage state estimation routine.

FIG. 11 is a flowchart illustrating a flow of processing of a neutral control routine.

FIG. 12 is a flowchart illustrating a flow of processing of an estimation value correction routine.

FIG. 13 is a flowchart illustrating a flow of processing of a sensor output characteristic control routine.

### DESCRIPTION OF EMBODIMENTS

Hereinafter, a specific example of an embodiment of the present disclosure will be described.

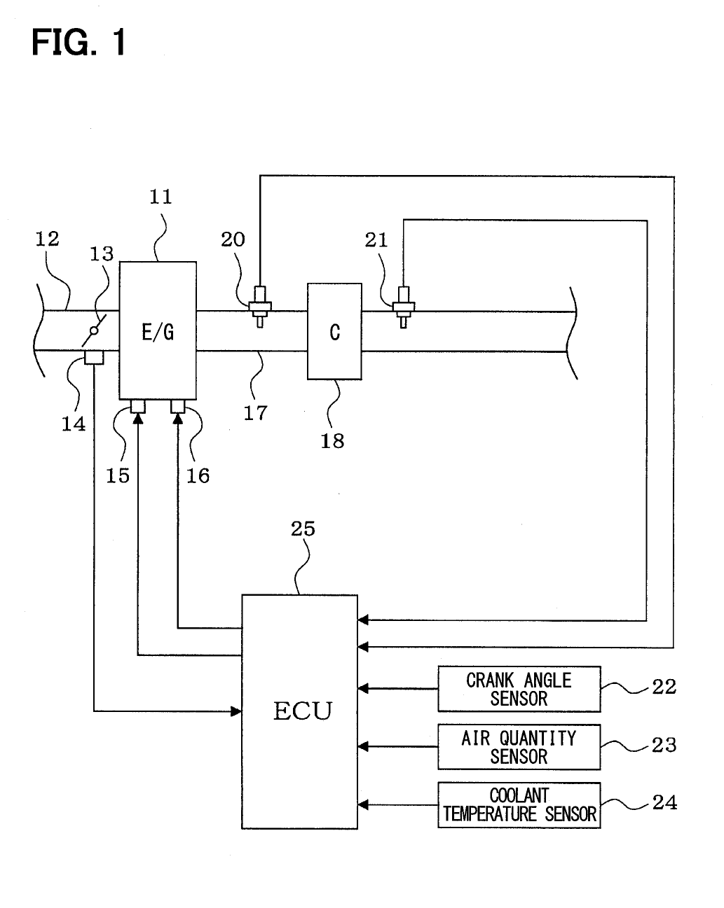

A schematic configuration of an engine control system as a whole will be described with reference to FIG. 1.

A throttle valve 13 that has a degree of opening regulated by a motor or the like and a throttle position sensor 14 that detects the degree of opening (throttle position) of the throttle valve 13 are disposed at an intake pipe 12 of an engine 11. A fuel injection valve 15, which performs in-cylinder injection or intake port injection, is attached to each cylinder of the engine 11, and an ignition plug 16 is attached to each cylinder in a cylinder head of the engine 11. Ignition is performed on an air-fuel mixture in the cylinder by spark discharge by each ignition plug 16.

A catalyst 18 such as a three-way catalyst, which removes CO, HC, NOx, and the like from exhaust gas, is disposed on an exhaust pipe 17 of the engine 11. An air-fuel ratio sensor 20 (linear A/F sensor) that outputs a linear air-fuel ratio signal corresponding to an air-fuel ratio of the exhaust gas is disposed on an upstream side of the catalyst 18 as an upstream-side exhaust gas sensor. An oxygen sensor 21 (O₂ sensor) that reverses an output voltage depending on whether the air-fuel ratio of the exhaust gas is rich or lean with respect to a stoichiometric air-fuel ratio is disposed on a downstream side of the catalyst 18 as a downstream-side exhaust gas sensor.

Various sensors are also disposed in this system, such as a crank angle sensor 22 that outputs a pulse signal every time a crankshaft (not illustrated) of the engine 11 rotates by a predetermined crank angle, an air quantity sensor 23 that detects the quantity of air introduced by the engine 11, and a coolant temperature sensor 24 that detects a temperature of a coolant for the engine 11. The crank angle and an engine rotation speed are detected based on an output signal output by the crank angle sensor 22.

Outputs from these various sensors are input to an electronic control unit (ECU) 25. This ECU 25 is configured to have a microcomputer as a main component and controls a fuel injection quantity, an ignition timing, the degree of throttle opening (intake air quantity), and the like in accordance with an engine operation state by executing various programs for engine control stored in a built-in ROM (storage medium).

When a predetermined air-fuel ratio F/B control execution condition has been satisfied at this time, the ECU 25 performs a main F/B control for feedback (F/B) correction of the air-fuel ratio (fuel injection quantity), based on the output from the air-fuel ratio sensor 20 (upstream-side exhaust gas sensor), so that the air-fuel ratio of the exhaust gas on the upstream side of the catalyst 18 corresponds to an upstream side target air-fuel ratio.

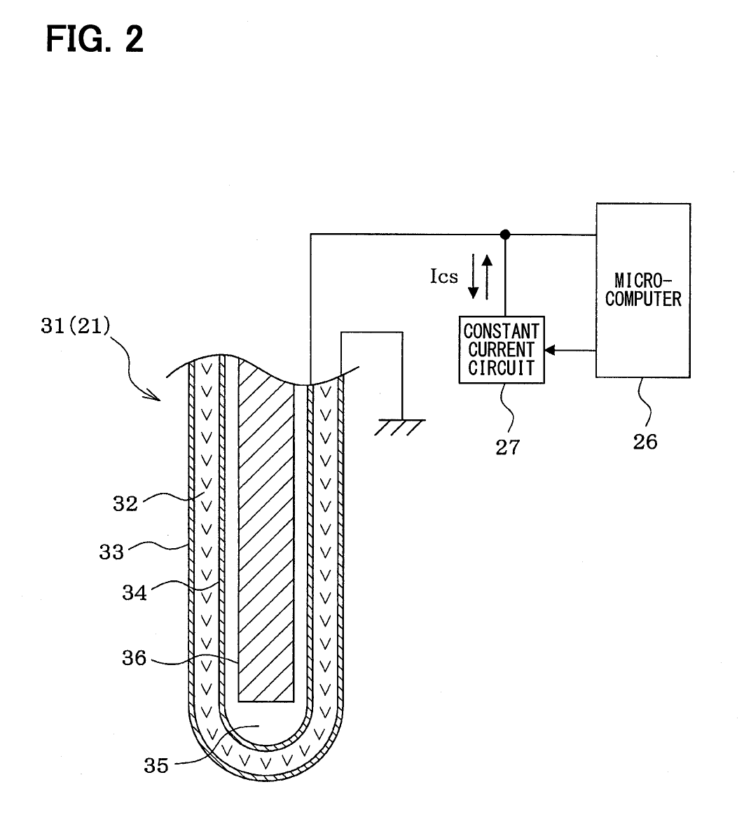

A configuration of the oxygen sensor 21 will be described below with reference to FIG. 2.

The oxygen sensor 21 has a sensor element 31 that has a cup-shaped structure. The entire sensor element 31 is configured to be accommodated in a housing (not illustrated) and an element cover (not illustrated) and is disposed in the exhaust pipe 17 of the engine 11.

A solid electrolyte layer 32 (solid electrolyte body) in the sensor element 31 is formed to have the cross-sectional shape of a cup, an exhaust-side electrode layer 33 is disposed on an outer surface of the solid electrolyte layer 32, and an atmosphere-side electrode layer 34 is disposed on an inner surface of the solid electrolyte layer 32. The solid electrolyte layer 32 is formed from an oxygen ion-conducting oxide sintered body in which CaO, MgO, Y₂O₃, Yb₂O₃, and the like are dissolved as stabilizers in ZrO₂, HfO₂, ThO₂, Bi₂O₃, and the like. Each of the electrode layers 33 and 34 is formed from a high-catalytic activity precious metal such as platinum, and porous chemical plating or the like has been carried out on a surface of each of the electrode layers 33 and 34. These electrode layers 33 and 34 are a pair of facing electrodes (sensor electrodes). An internal space that is surrounded by the solid electrolyte layer 32 is an atmospheric chamber 35, and a heater 36 is accommodated in the atmospheric chamber 35. This heater 36 has a heat generation capacity that is sufficient for activation of the sensor element 31, and the entire sensor element 31 is heated by exothermic energy of the heater 36. The oxygen sensor 21 has an active temperature of, for example, approximately 350° C. to 400° C. A predetermined oxygen concentration is maintained in the atmospheric chamber 35 as a result of atmosphere introduction.

In the sensor element 31, an outer side of the solid electrolyte layer 32 (electrode layer 33 side) has an exhaust atmosphere and an inner side of the solid electrolyte layer 32 (electrode layer 34 side) has an air atmosphere, and an electromotive force is generated between the electrode layers 33 and 34 in response to an oxygen concentration difference between the outer and inner sides (difference in oxygen partial pressure). In other words, in the sensor element 31, different electromotive forces are generated depending on whether the air-fuel ratio is rich or lean. Accordingly, the oxygen sensor 21 outputs an electromotive force signal in accordance with the oxygen concentration of the exhaust gas (that is, the air-fuel ratio).

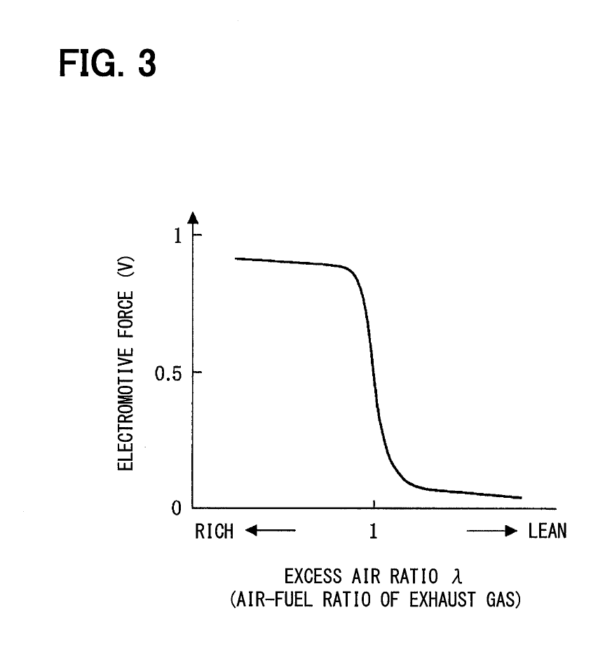

As illustrated in FIG. 3, the sensor element 31 generates the different electromotive forces depending on whether the air-fuel ratio is rich or lean with respect to the stoichiometric air-fuel ratio (excess air ratio λ=1), and the electromotive force rapidly changes in the vicinity of the stoichiometric air-fuel ratio (excess air ratio λ=1). Specifically, the sensor electromotive force at a time of rich fuel is approximately 0.9 V and the sensor electromotive force at a time of lean fuel is approximately 0 V.

As illustrated in FIG. 2, the exhaust-side electrode layer 33 of the sensor element 31 is grounded and a microcomputer 26 is connected to the atmosphere-side electrode layer 34. When the electromotive force is generated by the sensor element 31 in accordance with the air-fuel ratio of the exhaust gas (oxygen concentration), a sensor detection signal that is equivalent to the electromotive force is output to the microcomputer 26.

The microcomputer 26 is disposed in, for example, the ECU 25 and calculates the air-fuel ratio based on the sensor detection signal. The microcomputer 26 may also calculate the engine rotation speed and the intake air quantity based on results of the detection by the various sensors described above.

When the engine 11 is in operation, an actual air-fuel ratio of the exhaust gas successively changes and, in some cases, repeatedly changes between rich and lean. An engine performance might be affected if the oxygen sensor 21 had a low level of detection responsiveness during this change in actual air-fuel ratio. For example, the amount of the NOx in the exhaust gas might exceed an intended amount during a high-load operation of the engine 11.

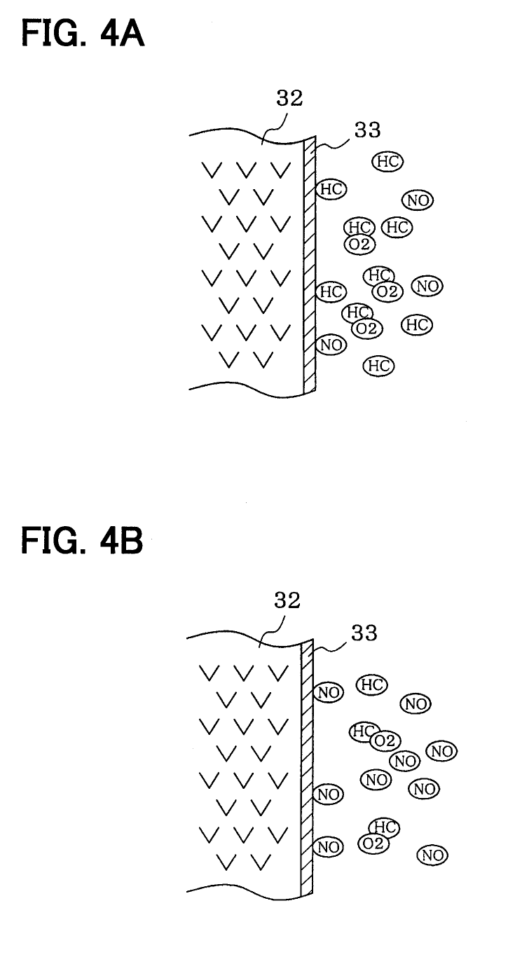

The detection responsiveness of the oxygen sensor 21 during the change in actual air-fuel ratio between rich and lean will be described below. When the actual air-fuel ratio of the exhaust gas discharged from the engine 11 (actual air-fuel ratio on the downstream side of the catalyst 18) changes, a component composition of the exhaust gas changes. At this time, remaining of an exhaust gas component immediately preceding that change delays a change in the output from the oxygen sensor 21 with respect to the air-fuel ratio following the change (that is, responsiveness of the sensor output). Specifically, at the time of a rich-to-lean change, HC or the like as a rich component remains in the vicinity of the exhaust-side electrode layer 33 immediately after the lean change as illustrated in FIG. 4A, and a reaction of a lean component (such as NOx) in the sensor electrode is impeded by this rich component. As a result, the lean output responsiveness declines on the part of the oxygen sensor 21. At the time of a lean-to-rich change, NOx or the like as the lean component remains in the vicinity of the exhaust-side electrode layer 33 immediately after the rich change as illustrated in FIG. 4B, and a reaction of the rich component (such as HC) in the sensor electrode is impeded by this lean component. As a result, the rich output responsiveness declines on the part of the oxygen sensor 21.

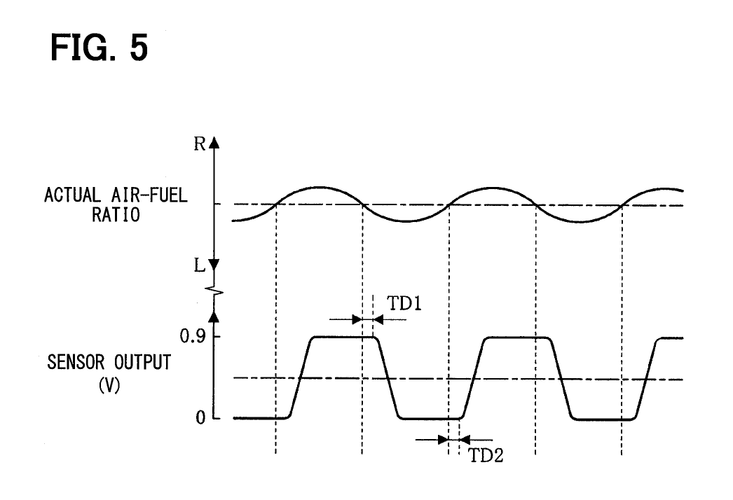

The change in the output from the oxygen sensor 21 will be described with reference to a time chart illustrated in FIG. 5. When the actual air-fuel ratio changes between rich and lean, the sensor output (output from the oxygen sensor 21) changes between a rich gas detection value (0.9 V) and a lean gas detection value (0 V) in response to that change in actual air-fuel ratio as illustrated in FIG. 5. In this case, the sensor output changes with a delay with respect to the change in actual air-fuel ratio. According to FIG. 5, the sensor output changes with a delay of TD1 with respect to the change in actual air-fuel ratio at the time of the rich-to-lean change and the sensor output changes with a delay of TD2 with respect to the change in actual air-fuel ratio at the time of the lean-to-rich change.

In the present example, the detection responsiveness is changed by a constant current circuit 27 as a constant current supply unit being connected to the atmosphere-side electrode layer 34 as illustrated in FIG. 2, supply of a constant current “Ics” by this constant current circuit 27 being controlled by the ECU 25 (microcomputer 26), a current flow in a predetermined direction being caused between the pair of sensor electrodes 33 and 34 (between the exhaust-side electrode layer 33 and the atmosphere-side electrode layer 34), and an output characteristic of the oxygen sensor 21 being changed. In this case, the microcomputer 26 sets the amount and direction of the constant current “Ics” flowing between the pair of sensor electrodes 33 and 34 and controls the constant current circuit 27 for the set constant current “Ics” to flow.

Specifically, the constant current circuit 27 supplies the constant current “Ics” to the atmosphere-side electrode layer 34 either in a forward direction or in a reverse direction and is capable of variably adjusting the amount of the constant current. In other words, the microcomputer 26 variably controls the constant current “Ics” by PWM control or the like. In this case, the constant current “Ics” is adjusted in the constant current circuit 27 in accordance with a duty signal output from the microcomputer 26, and the amount-adjusted constant current “Ics” flows between the sensor electrodes 33 and 34 (between the exhaust-side electrode layer 33 and the atmosphere-side electrode layer 34).

In the present example, the constant current “Ics” that flows from the exhaust-side electrode layer 33 to the atmosphere-side electrode layer 34 is a negative constant current (−Ics) and the constant current “Ics” that flows from the atmosphere-side electrode layer 34 to the exhaust-side electrode layer 33 is a positive constant current (+Ics).

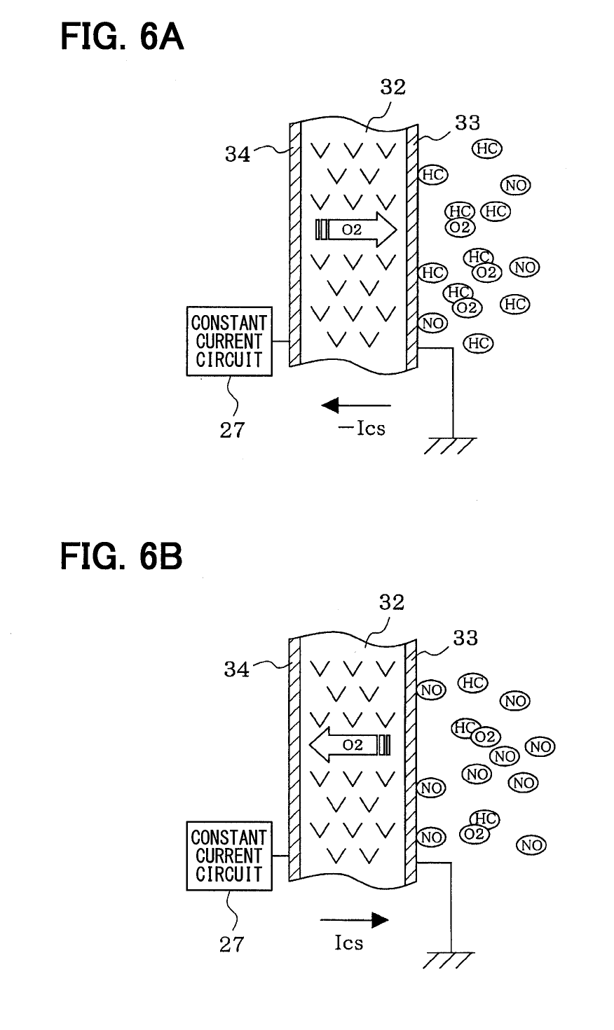

In the case of, for example, an increase in the detection responsiveness at the time of the rich-to-lean change (lean sensitivity), the constant current “Ics” (negative constant current “Ics”) flows as illustrated in FIG. 6A such that oxygen is supplied from the atmosphere-side electrode layer 34 to the exhaust-side electrode layer 33 through the solid electrolyte layer 32. In this case, an oxidation reaction is promoted with regard to the rich component (HC) present (remaining) around the exhaust-side electrode layer 33 by the oxygen supply from the atmosphere side to the exhaust side, and thus the rich component can be quickly removed. Accordingly, the lean component (NOx) becomes more likely to react in the exhaust-side electrode layer 33, which results in an improvement of the lean output responsiveness of the oxygen sensor 21.

In the case of an increase in the detection responsiveness at the time of the lean-to-rich change (rich sensitivity), the constant current “Ics” (positive constant current “Ics”) flows as illustrated in FIG. 6B such that oxygen is supplied from the exhaust-side electrode layer 33 to the atmosphere-side electrode layer 34 through the solid electrolyte layer 32. In this case, a reduction reaction is promoted with regard to the lean component (NOx) present (remaining) around the exhaust-side electrode layer 33 by the oxygen supply from the exhaust side to the atmosphere side, and thus the lean component can be quickly removed. Accordingly, the rich component (HC) becomes more likely to react in the exhaust-side electrode layer 33, which results in an improvement of the rich output responsiveness of the oxygen sensor 21.

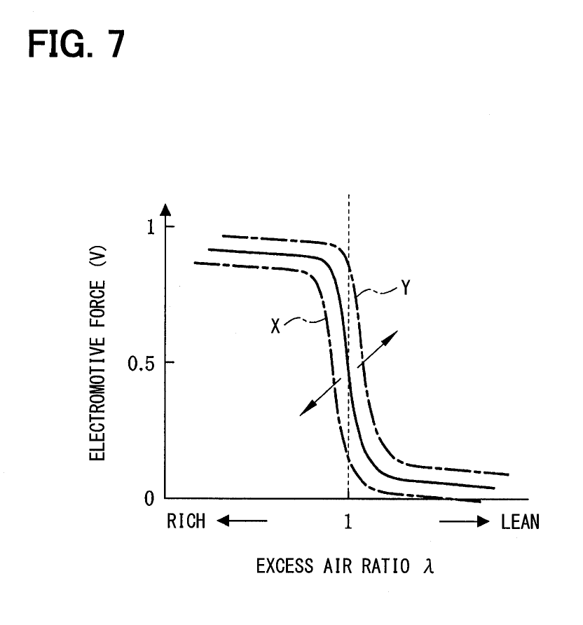

FIG. 7 is a diagram illustrating the output characteristic (electromotive force characteristic) of the oxygen sensor 21 in the case of the increase in the detection responsiveness at the time of the lean change (lean sensitivity) and in the case of the increase in the detection responsiveness at the time of the rich change (rich sensitivity).

When the negative constant current “Ics” flows for the above-described oxygen supply from the atmosphere-side electrode layer 34 to the exhaust-side electrode layer 33 through the solid electrolyte layer 32 in the case of the increase in the detection responsiveness at the time of the lean change (lean sensitivity) (refer to FIG. 6A), an output characteristic line shifts to the rich side as illustrated by Line X in FIG. 7 (more specifically, the output characteristic line shifts to the rich side and a side of electromotive force decrease). In this case, the sensor output is the lean output even if the actual air-fuel ratio is in a rich region in the vicinity of the stoichiometric air-fuel ratio. This is an enhanced detection responsiveness at the time of the lean change (lean sensitivity) as the output characteristic of the oxygen sensor 21.

When the positive constant current “Ics” flows for the above-described oxygen supply from the exhaust-side electrode layer 33 to the atmosphere-side electrode layer 34 through the solid electrolyte layer 32 in the case of the increase in the detection responsiveness at the time of the rich change (rich sensitivity) (refer to FIG. 6B), the output characteristic line shifts to the lean side as illustrated by Line Y in FIG. 7 (more specifically, the output characteristic line shifts to the lean side and a side of electromotive force increase). In this case, the sensor output is the rich output even if the actual air-fuel ratio is in a lean region in the vicinity of the stoichiometric air-fuel ratio. This is an enhanced detection responsiveness at the time of the rich change (rich sensitivity) as the output characteristic of the oxygen sensor 21.

A case where an oxygen storage state of the catalyst 18 is a neutral state (state in the middle between a lean state where an oxygen storage quantity is large and a rich state where the oxygen storage quantity is small) is a state where an ability to maintain the air-fuel ratio in the catalyst 18 in purification window is maximized (that is, a state where robustness is high with respect to a fluctuation of the air-fuel ratio on the upstream side of the catalyst 18).

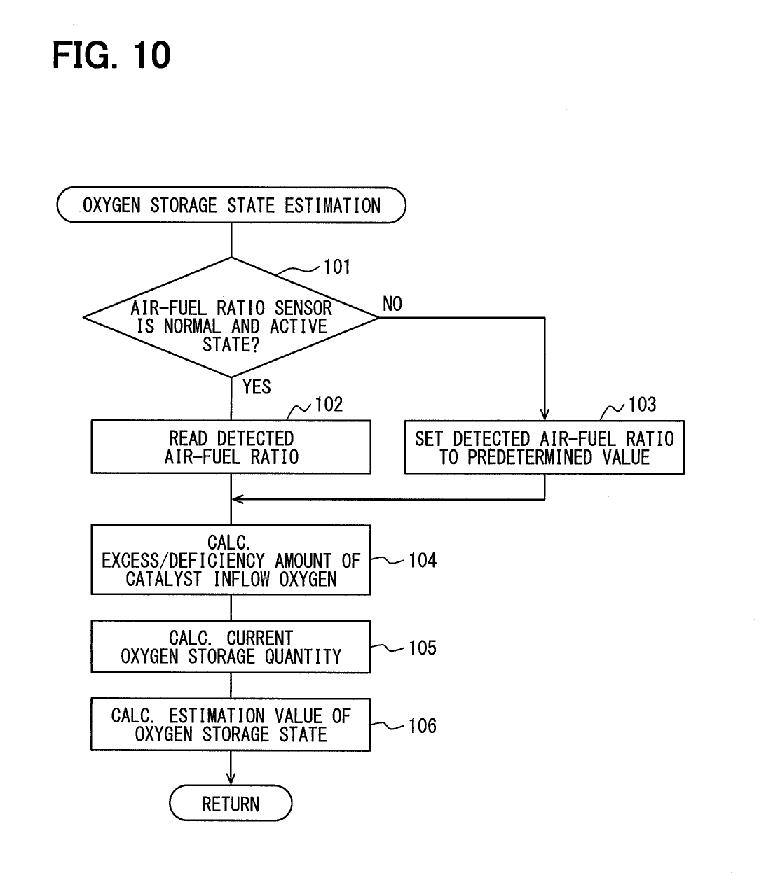

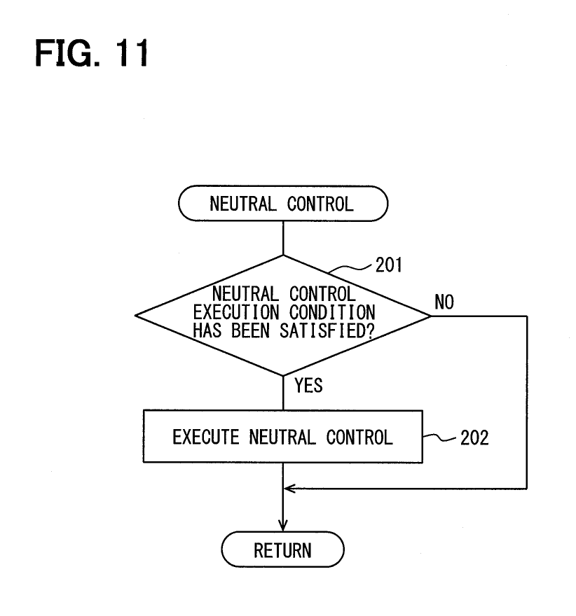

The ECU 25 estimates the oxygen storage state of the catalyst 18 based on the output from the air-fuel ratio sensor 20 (upstream-side exhaust gas sensor) by executing an oxygen storage state estimation routine (described later) illustrated in FIG. 10 and controls the oxygen storage state of the catalyst 18 based on an estimation value of the oxygen storage state, so that the oxygen storage state of the catalyst 18 corresponds to the neutral state, by executing a neutral control routine (described later) illustrated in FIG. 11.

During the estimation of the oxygen storage state of the catalyst 18 based on the output from the air-fuel ratio sensor 20 (air-fuel ratio on the upstream side of the catalyst 18), an oxygen storage state estimation error might arise due to a variation or a fluctuation in catalyst characteristics and this error might deteriorate accuracy of the estimation. When a state where the accuracy of the oxygen storage state estimation is deteriorated continues, an actual oxygen storage state of the catalyst 18 cannot be maintained in the neutral state and a sufficient reduction in exhaust emission might be impossible.

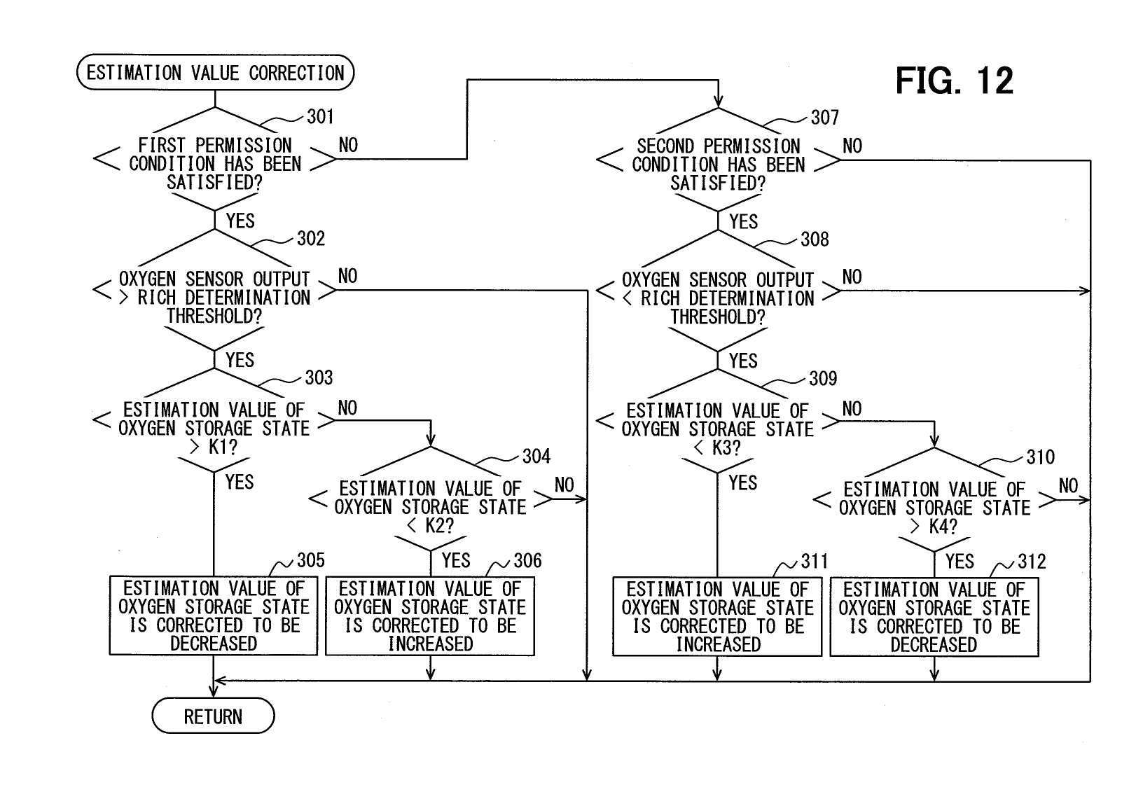

In this regard, the ECU 25 determines the accuracy of the oxygen storage state estimation based on the estimation value of the oxygen storage state and the output from the oxygen sensor 21 (downstream-side exhaust gas sensor) by executing an estimation value correction routine (described later) illustrated in FIG. 12 and corrects the estimation value of the oxygen storage state for a restriction on the deterioration of the estimation accuracy.

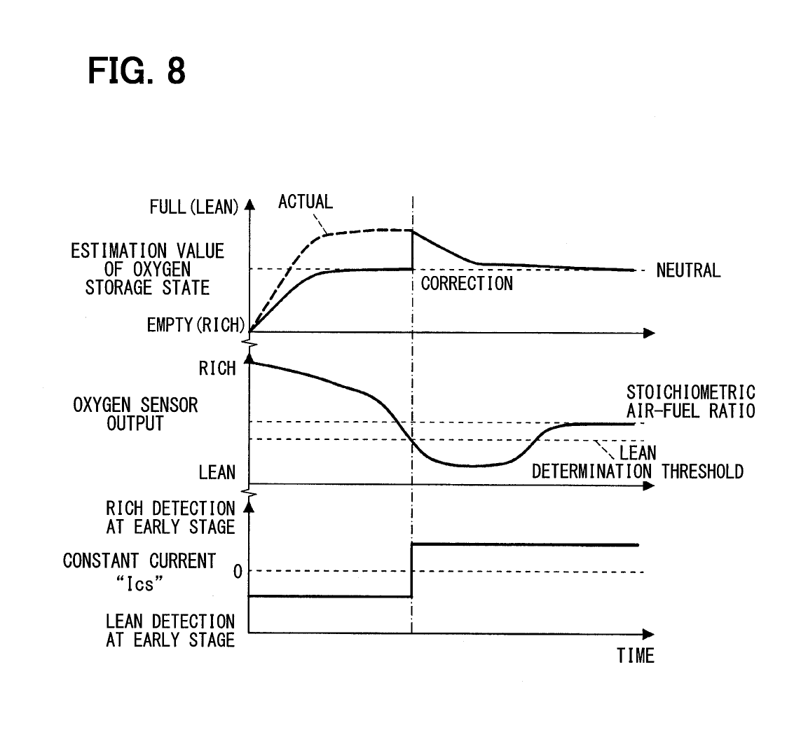

Specifically, in a case where the estimation value of the oxygen storage state is further on the rich side than a predetermined determination value when the output from the oxygen sensor 21 has moved to the lean side from the rich side with respect to a predetermined threshold (lean determination threshold) as illustrated in FIG. 8, it is determined that the estimation value of the oxygen storage state has deviated in the rich direction with respect to the actual oxygen storage state (that the accuracy of the oxygen storage state estimation has deteriorated) and the estimation value of the oxygen storage state is corrected in the lean direction.

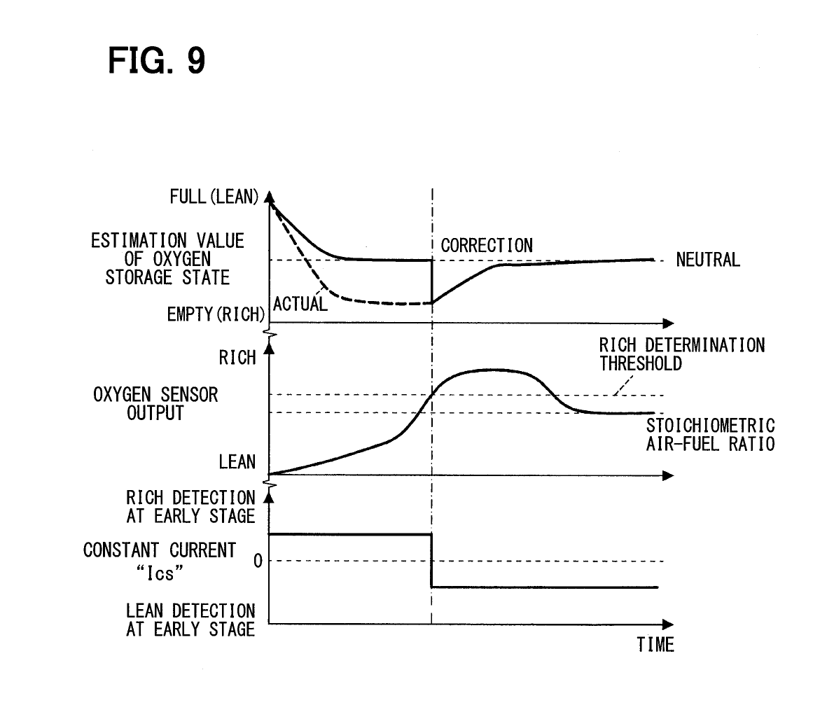

In a case where the estimation value of the oxygen storage state is further on the lean side than the predetermined determination value when the output from the oxygen sensor 21 has moved to the rich side from the lean side with respect to a predetermined threshold (rich determination threshold) as illustrated in FIG. 9, it is determined that the estimation value of the oxygen storage state has deviated in the lean direction with respect to the actual oxygen storage state (that the accuracy of the oxygen storage state estimation has deteriorated) and the estimation value of the oxygen storage state is corrected in the rich direction.

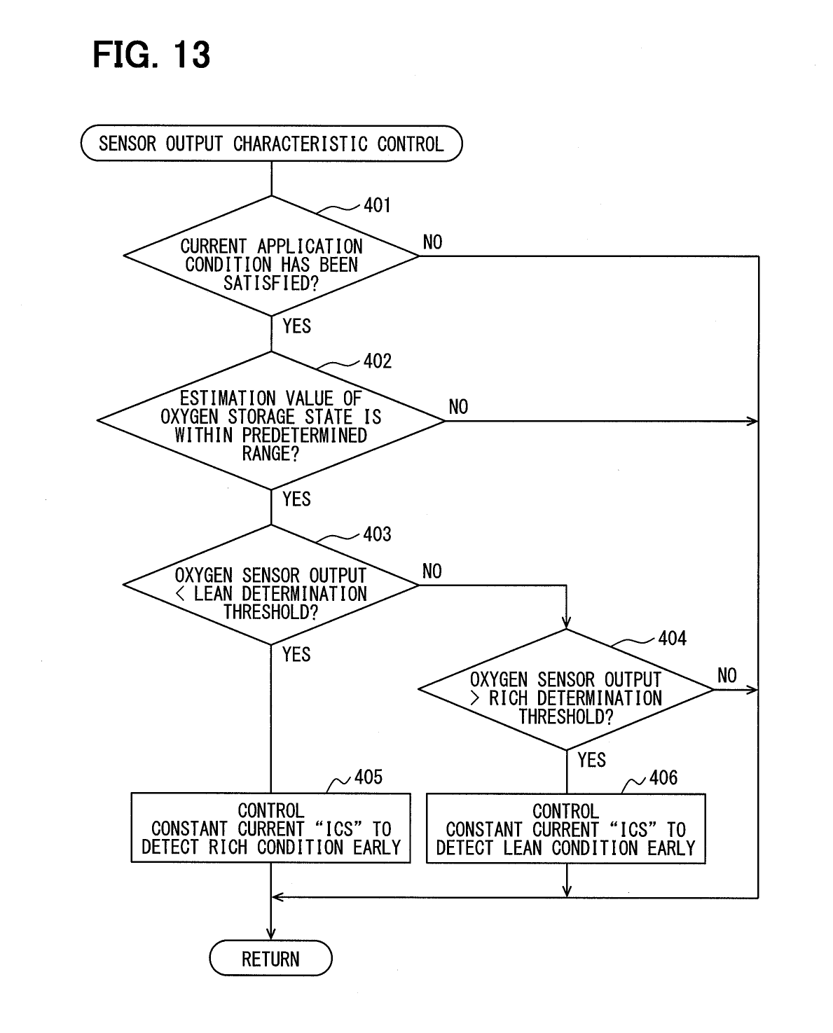

In addition, the ECU 25 changes the output characteristic of the oxygen sensor 21 as follows by executing a sensor output characteristic control routine (described later) illustrated in FIG. 13 in order to detect the deterioration of the accuracy of the estimation of the oxygen storage state of the catalyst 18 at an early stage.

In the case of a transition of the output from the oxygen sensor 21 to the lean side from the rich side with respect to a stoichiometric air-fuel ratio equivalent output (stoichiometric air-fuel ratio equivalent output), the constant current circuit 27 is controlled such that the constant current “Ics” flows in a direction in which rich detection by the oxygen sensor 21 is brought forward (direction in which the rich responsiveness increases) as illustrated in FIG. 8. Then, the lean-to-rich change in the air-fuel ratio in the catalyst 18 can be detected at an early stage by the oxygen sensor 21.

In the case of a transition of the output from the oxygen sensor 21 to the rich side from the lean side with respect to the stoichiometric air-fuel ratio equivalent output, the constant current circuit 27 is controlled such that the constant current “Ics” flows in a direction in which lean detection by the oxygen sensor 21 is brought forward (direction in which the lean responsiveness increases) as illustrated in FIG. 9. Then, the rich-to-lean change in the air-fuel ratio in the catalyst 18 can be detected at an early stage by the oxygen sensor 21.

The above-described change in the output characteristic of the oxygen sensor 21 allows a change in the air-fuel ratio in the catalyst 18 (that is, a change in the actual oxygen storage state of the catalyst 18) to be detected at an early stage based on the output from the oxygen sensor 21, and thus the deterioration of the accuracy of the oxygen storage state estimation can be detected at an early stage.

Hereinafter, processing content of each of the routines that are illustrated in FIGS. 10 to 13 and executed by the ECU 25 according to the present example will be described.

### [Oxygen Storage State Estimation Routine]

The oxygen storage state estimation routine that is illustrated in FIG. 10 is repeatedly executed at a predetermined cycle during a power ON period of the ECU 25 and fulfills a role as an estimation unit. After this routine is started, it is first determined in Step 101 whether or not the air-fuel ratio sensor 20 is in a normal (no abnormality) and active state.

In a case where it is determined in this Step 101 that the air-fuel ratio sensor 20 is in the normal and active state, the processing proceeds to Step 102 and the air-fuel ratio detected by the air-fuel ratio sensor 20 is read as a detected air-fuel ratio.

In a case where it is determined in Step 101 that the air-fuel ratio sensor 20 is not in the normal and active state (that the air-fuel ratio sensor 20 is abnormal or the air-fuel ratio sensor 20 has yet to become active), the processing proceeds to Step 103 and the detected air-fuel ratio is set to a predetermined value. This predetermined value is, for example, an air-fuel ratio calculated based on the engine operation state (such as the intake air quantity and the fuel injection quantity).

Then, the processing proceeds to Step 104, in which a deviation between a neutral air-fuel ratio (air-fuel ratio at which the oxygen storage state of the catalyst 18 corresponds to the neutral state) and the detected air-fuel ratio is calculated and a catalyst inflow oxygen excess/deficiency amount (excess/deficiency amount of oxygen with respect to the quantity of the oxygen that flows into the catalyst 18 in the case of the neutral air-fuel ratio) is calculated based on this deviation and an exhaust gas flow rate.

Then, the processing proceeds to Step 105, in which a current oxygen storage quantity of the catalyst 20 is calculated based on the catalyst inflow oxygen excess/deficiency amount, a previous oxygen storage quantity of the catalyst 20 (previously calculated value of the oxygen storage quantity), a maximum oxygen storage quantity of the catalyst 20, and a reaction coefficient.

Then, the processing proceeds to Step 106, in which the estimation value of the oxygen storage state of the catalyst 20 (such as a ratio of the current oxygen storage quantity to the maximum oxygen storage quantity) is calculated based on the maximum oxygen storage quantity and the current oxygen storage quantity of the catalyst 20.

### [Neutral Control Routine]

The neutral control routine that is illustrated in FIG. 11 is repeatedly executed at a predetermined cycle during the power ON period of the ECU 25 and fulfills a role as a neutral control unit. In Step 201, whether or not a neutral control execution condition has been satisfied is determined based on, for example, whether or not the air-fuel ratio F/B control execution condition (such as a main F/B control execution condition) has been satisfied.

In a case where it is determined in this Step 201 that the neutral control execution condition has yet to be satisfied, this routine is terminated without the processing of Step 202 being executed.

In a case where it is determined in Step 201 that the neutral control execution condition has been satisfied, the processing proceeds to Step 202 and the neutral control is executed. In this neutral control, the oxygen storage state of the catalyst 18 is controlled such that the oxygen storage state of the catalyst 18 corresponds to the neutral state by the fuel injection quantity or the upstream side target air-fuel ratio (target air-fuel ratio for the main F/B control) being corrected so that the estimation value of the oxygen storage state approximates to a target value of the oxygen storage state (value equivalent to the neutral state).

### [Estimation Value Correction Routine]

The estimation value correction routine that is illustrated in FIG. 12 is repeatedly executed at a predetermined cycle during the power ON period of the ECU 25 and fulfills a role as an estimation value correction unit. In Step 301, it is determined whether or not a first permission condition has been satisfied. In this case, whether or not the first permission condition has been satisfied is determined based on, for example, whether or not the output from the oxygen sensor 21 has never exceeded the predetermined threshold (rich determination threshold) since the oxygen storage state of the catalyst 18 became an over-lean state (such as 100% or the vicinity thereof) and the output from the oxygen sensor 21 was further on the lean side than the stoichiometric air-fuel ratio equivalent output.

In a case where it is determined in this Step 301 that the first permission condition has been satisfied, the processing proceeds to Step 302 and it is determined whether or not the output from the oxygen sensor 21 has exceeded the rich determination threshold (has moved to the rich side). This rich determination threshold is set, for example, to the stoichiometric air-fuel ratio equivalent output or on the rich side that falls short of the stoichiometric air-fuel ratio equivalent output.

In a case where it is determined in this Step 302 that the output from the oxygen sensor 21 is at or below the rich determination threshold, this routine is terminated without the processing starting from Step 303 being executed.

The processing proceeds to Step 303, in which it is determined whether or not the estimation value of the oxygen storage state exceeds a determination value K1 (lean side), once it is determined in Step 302 that the output from the oxygen sensor 21 has exceeded the rich determination threshold (has moved to the rich side). The determination value K1 is set to, for example, a neutral state equivalent value or a value in the vicinity thereof.

In a case where it is determined in this Step 303 that the estimation value of the oxygen storage state exceeds the determination value K1 (lean side), it is determined that the estimation value of the oxygen storage state has deviated in the lean direction (that the accuracy of the oxygen storage state estimation has deteriorated) and the processing proceeds to Step 305, in which the estimation value of the oxygen storage state is reduced by the estimation value of the oxygen storage state being corrected in a direction of decrease (rich direction). In this case, the estimation value of the oxygen storage state is corrected in the direction of decrease by, for example, the maximum oxygen storage quantity that is used during the calculation of the estimation value of the oxygen storage state being increased. Alternatively, the estimation value of the oxygen storage state may be corrected in the direction of decrease by the neutral air-fuel ratio that is used during the calculation of the estimation value of the oxygen storage state being corrected to the lean side (or by the reaction coefficient being corrected). In addition, the estimation value of the oxygen storage state may be corrected in the direction of decrease by the estimation value of the oxygen storage state being multiplied by a predetermined coefficient α1 (α1<1).

In a case where it is determined in Step 303 that the estimation value of the oxygen storage state is equal to or less than the determination value K1, the processing proceeds to Step 304 and it is determined whether or not the estimation value of the oxygen storage state is less than a determination value K2 (rich side). This determination value K2 is set further on the rich side than the determination value K1.

In a case where it is determined in this Step 304 that the estimation value of the oxygen storage state is less than the determination value K2 (rich side), it is determined that the estimation value of the oxygen storage state has deviated in the rich direction (that the accuracy of the oxygen storage state estimation has deteriorated) and the processing proceeds to Step 306, in which the estimation value of the oxygen storage state is increased by the estimation value of the oxygen storage state being corrected in a direction of increase (lean direction). In this case, the estimation value of the oxygen storage state is corrected in the direction of increase by, for example, the maximum oxygen storage quantity that is used during the calculation of the estimation value of the oxygen storage state being reduced. Alternatively, the estimation value of the oxygen storage state may be corrected in the direction of increase by the neutral air-fuel ratio that is used during the calculation of the estimation value of the oxygen storage state being corrected to the rich side (or by the reaction coefficient being corrected). In addition, the estimation value of the oxygen storage state may be corrected in the direction of increase by the estimation value of the oxygen storage state being multiplied by a predetermined coefficient α2 (α2>1).

In a case where it is determined in Step 303 that the estimation value of the oxygen storage state is equal to or less than the determination value K1 and it is determined in Step 304 that the estimation value of the oxygen storage state is equal to or greater than the determination value K2, it is determined that the accuracy of the oxygen storage state estimation has not deteriorated and this routine is terminated without the estimation value of the oxygen storage state being corrected.

In a case where it is determined in Step 301 that the first permission condition has yet to be satisfied, the processing proceeds to Step 307 and it is determined whether or not a second permission condition has been satisfied. In this case, whether or not the second permission condition has been satisfied is determined based on, for example, whether or not the output from the oxygen sensor 21 has never fallen below the predetermined threshold (lean determination threshold) since the oxygen storage state of the catalyst 18 became an over-rich state (such as 0% or the vicinity thereof) and the output from the oxygen sensor 21 was further on the rich side than the stoichiometric air-fuel ratio equivalent output.

In a case where it is determined in this Step 307 that the second permission condition has been satisfied, the processing proceeds to Step 308 and it is determined whether or not the output from the oxygen sensor 21 has fallen below the lean determination threshold (has moved to the lean side). This lean determination threshold is set, for example, to the stoichiometric air-fuel ratio equivalent output or on the lean side that falls short of the stoichiometric air-fuel ratio equivalent output.

In a case where it is determined in this Step 308 that the output from the oxygen sensor 21 is at or above the lean determination threshold, this routine is terminated without the processing starting from Step 309 being executed.

The processing proceeds to Step 309, in which it is determined whether or not the estimation value of the oxygen storage state falls short of a determination value K3 (rich side), once it is determined in Step 308 that the output from the oxygen sensor 21 has fallen below the lean determination threshold (has moved to the lean side). The determination value K3 is set to, for example, the neutral state equivalent value or a value in the vicinity thereof.

In a case where it is determined in this Step 309 that the estimation value of the oxygen storage state falls short of the determination value K3 (rich side), it is determined that the estimation value of the oxygen storage state has deviated in the rich direction (that the accuracy of the oxygen storage state estimation has deteriorated) and the processing proceeds to Step 311, in which the estimation value of the oxygen storage state is increased by the estimation value of the oxygen storage state being corrected in the direction of increase (lean direction). In this case, the estimation value of the oxygen storage state is corrected in the direction of increase by, for example, the maximum oxygen storage quantity that is used during the calculation of the estimation value of the oxygen storage state being reduced. Alternatively, the estimation value of the oxygen storage state may be corrected in the direction of increase by the neutral air-fuel ratio that is used during the calculation of the estimation value of the oxygen storage state being corrected to the rich side (or by the reaction coefficient being corrected). In addition, the estimation value of the oxygen storage state may be corrected in the direction of increase by the estimation value of the oxygen storage state being multiplied by a predetermined coefficient α3 (α3>1).

In a case where it is determined in Step 309 that the estimation value of the oxygen storage state is equal to or greater than the determination value K3, the processing proceeds to Step 310 and it is determined whether or not the estimation value of the oxygen storage state is greater than a determination value K4 (lean side). This determination value K4 is set further on the lean side than the determination value K3.

In a case where it is determined in this Step 310 that the estimation value of the oxygen storage state is greater than the determination value K4 (lean side), it is determined that the estimation value of the oxygen storage state has deviated in the lean direction (that the accuracy of the oxygen storage state estimation has deteriorated) and the processing proceeds to Step 312, in which the estimation value of the oxygen storage state is reduced by the estimation value of the oxygen storage state being corrected in the direction of decrease (rich direction). In this case, the estimation value of the oxygen storage state is corrected in the direction of decrease by, for example, the maximum oxygen storage quantity that is used during the calculation of the estimation value of the oxygen storage state being increased. Alternatively, the estimation value of the oxygen storage state may be corrected in the direction of decrease by the neutral air-fuel ratio that is used during the calculation of the estimation value of the oxygen storage state being corrected to the lean side (or by the reaction coefficient being corrected). In addition, the estimation value of the oxygen storage state may be corrected in the direction of decrease by the estimation value of the oxygen storage state being multiplied by a predetermined coefficient α4 (α4<1).

In a case where it is determined in Step 309 that the estimation value of the oxygen storage state is equal to or greater than the determination value K3 and it is determined in Step 310 that the estimation value of the oxygen storage state is equal to or less than the determination value K4, it is determined that the accuracy of the oxygen storage state estimation has not deteriorated and this routine is terminated without the estimation value of the oxygen storage state being corrected.

In a case where the estimation value of the oxygen storage state is corrected by the maximum oxygen storage quantity being corrected in the routine that is illustrated in FIG. 12, degradation diagnosis may be performed on the catalyst 18 based on the maximum oxygen storage quantity following the correction. In this case, it is determined that the catalyst 18 has degraded when, for example, the maximum oxygen storage quantity following the correction has become equal to or less than a predetermined degradation determination value.

### [Sensor Output Characteristic Control Routine]

The sensor output characteristic control routine that is illustrated in FIG. 13 is repeatedly executed at a predetermined cycle during the power ON period of the ECU 25 and fulfills a role as a sensor output characteristic control unit. In Step 401, whether or not a predetermined current application condition has been satisfied is determined based on whether or not the oxygen sensor 21 is normal (no abnormality), whether or not the oxygen sensor 21 is in an active state, or the like. In a case where it is determined that the current application condition has yet to be satisfied, this routine is terminated without the processing starting from Step 402 being executed.

In a case where it is determined in Step 401 that the current application condition has been satisfied, the processing proceeds to Step 402 and it is determined whether or not the estimation value of the oxygen storage state is within a predetermined range (such as a range equivalent to the neutral state and the vicinity thereof).

In a case where it is determined in this Step 402 that the estimation value of the oxygen storage state is out of the predetermined range, this routine is terminated without the processing starting from Step 403 being executed.

In a case where it is determined in Step 402 that the estimation value of the oxygen storage state is within the predetermined range, the processing proceeds to Step 403 and it is determined whether or not the output from the oxygen sensor 21 has fallen below the lean determination threshold (has moved to the lean side). This lean determination threshold is set, for example, to the stoichiometric air-fuel ratio equivalent output or on the lean side that falls short of the stoichiometric air-fuel ratio equivalent output. A single value may be set as both the lean determination threshold that is used in this Step 403 and the lean determination threshold that is used in Step 308 illustrated in FIG. 12 or different values may be set as the lean determination threshold that is used in this Step 403 and the lean determination threshold that is used in Step 308 illustrated in FIG. 12.

When it is determined in this Step 403 that the output from the oxygen sensor 21 has fallen below the lean determination threshold (has moved to the lean side), it is determined that the transition of the output from the oxygen sensor 21 to the lean side from the rich side with respect to the stoichiometric air-fuel ratio equivalent output has occurred, and then the processing proceeds to Step 405, in which the constant current circuit 27 is controlled such that the constant current “Ics” flows in the direction in which the rich detection by the oxygen sensor 21 is brought forward.

In a case where it is determined in Step 403 that the output from the oxygen sensor 21 is at or above the lean determination threshold, the processing proceeds to Step 404 and it is determined whether or not the output from the oxygen sensor 21 has exceeded the rich determination threshold (has moved to the rich side). This rich determination threshold is set, for example, to the stoichiometric air-fuel ratio equivalent output or on the rich side that falls short of the stoichiometric air-fuel ratio equivalent output. A single value may be set as both the rich determination threshold that is used in this Step 404 and the rich determination threshold that is used in Step 302 illustrated in FIG. 12 or different values may be set as the rich determination threshold that is used in this Step 404 and the rich determination threshold that is used in Step 302 illustrated in FIG. 12.

When it is determined in this Step 404 that the output from the oxygen sensor 21 has exceeded the rich determination threshold (has moved to the rich side), it is determined that the transition of the output from the oxygen sensor 21 to the rich side from the lean side with respect to the stoichiometric air-fuel ratio equivalent output has occurred, and then the processing proceeds to Step 406, in which the constant current circuit 27 is controlled such that the constant current “Ics” flows in the direction in which the lean detection by the oxygen sensor 21 is brought forward.

In the present example described above, the constant current circuit 27 is controlled such that the constant current “Ics” flows in the direction in which the rich detection by the oxygen sensor 21 is brought forward in the case of the transition of the output from the oxygen sensor 21 to the lean side from the rich side with respect to the stoichiometric air-fuel ratio equivalent output. Accordingly, the lean-to-rich change in the air-fuel ratio in the catalyst 18 can be detected at an early stage by the oxygen sensor 21.

In the case of the transition of the output from the oxygen sensor 21 to the rich side from the lean side with respect to the stoichiometric air-fuel ratio equivalent output, the constant current circuit 27 is controlled such that the constant current “Ics” flows in the direction in which the lean detection by the oxygen sensor 21 is brought forward. Accordingly, the rich-to-lean change in the air-fuel ratio in the catalyst 18 can be detected at an early stage by the oxygen sensor 21.

The above-described change in the output characteristic of the oxygen sensor 21 allows a change in the air-fuel ratio in the catalyst 18 (that is, a change in the actual oxygen storage state of the catalyst 18) to be detected at an early stage based on the output from the oxygen sensor 21, and thus the deterioration of the accuracy of the oxygen storage state estimation can be detected at an early stage. As a result, the deterioration of the accuracy of the estimation of the oxygen storage state of the catalyst 18 can be promptly restricted by the estimation value of the oxygen storage state being corrected at an early stage so that the deterioration of the accuracy of the estimation of the oxygen storage state of the catalyst 18 is restricted.

In the case where the estimation value of the oxygen storage state is further on the lean side than the predetermined determination value when the output from the oxygen sensor 21 has moved to the rich side with respect to the predetermined threshold (rich determination threshold) in the present example, it is determined that the estimation value of the oxygen storage state has deviated in the lean direction with respect to the actual oxygen storage state (that the accuracy of the oxygen storage state estimation has deteriorated) and the estimation value of the oxygen storage state is corrected in the rich direction. Accordingly, the deviation of the estimation value of the oxygen storage state in the lean direction can be promptly modified.

In the case where the estimation value of the oxygen storage state is further on the rich side than the predetermined determination value when the output from the oxygen sensor 21 has moved to the lean side with respect to the predetermined threshold (lean determination threshold), it is determined that the estimation value of the oxygen storage state has deviated in the rich direction with respect to the actual oxygen storage state (that the accuracy of the oxygen storage state estimation has deteriorated) and the estimation value of the oxygen storage state is corrected in the lean direction. Accordingly, the deviation of the estimation value of the oxygen storage state in the rich direction can be promptly modified.

According to the present example, the oxygen storage state is controlled based on the estimation value of the oxygen storage state such that the oxygen storage state corresponds to the neutral state, and thus the air-fuel ratio in the catalyst 18 can be maintained in the purification window with high robustness and the exhaust emission can be reduced.

Although the above-described example is configured for the constant current circuit 27 to be connected to the atmosphere-side electrode layer 34 of the oxygen sensor 21 (sensor element 31), the present disclosure is not limited thereto and may be configured, for example, for the constant current circuit 27 to be connected to the exhaust-side electrode layer 33 of the oxygen sensor 21 (sensor element 31) or for the constant current circuit 27 to be connected to both the exhaust-side electrode layer 33 and the atmosphere-side electrode layer 34.

According to the above-described example, the present disclosure is applied to the system that uses the oxygen sensor 21 which has the sensor element 31 having the cup-shaped structure. The present disclosure is not limited thereto. For example, the present disclosure may also be applied to a system that uses an oxygen sensor which has a layered structure-type sensor element.

According to the above-described example, the present disclosure is applied to the system in which the air-fuel ratio sensor is installed on an upstream side of an upstream side catalyst and the oxygen sensor is installed on a downstream side of the upstream side catalyst. The present disclosure is not limited thereto. The present disclosure can be applied to a system in which an exhaust gas sensor (oxygen sensor or air-fuel ratio sensor) is installed on each of an upstream side and a downstream side of a catalyst for exhaust gas purification.

1. An exhaust gas purification device for an internal combustion engine provided with an exhaust gas purification catalyst for an internal combustion engine, an upstream-side exhaust gas sensor and a downstream-side exhaust gas sensor respectively detecting an air-fuel ratio or rich/lean of exhaust gas on an upstream side and a downstream side of the catalyst, and a constant current supply unit changing an output characteristic of the downstream-side exhaust gas sensor by causing a constant current to flow between sensor electrodes of the downstream-side exhaust gas sensor, the exhaust gas purification device for an internal combustion engine comprising:
an estimation unit estimating an oxygen storage state of the catalyst based on an output of the upstream-side exhaust gas sensor;
an estimation value correction unit determining accuracy of the oxygen storage state estimation based on an estimation value of the oxygen storage state and an output of the downstream-side exhaust gas sensor and correcting the estimation value of the oxygen storage state such that deterioration of the accuracy of the estimation is restricted; and
a sensor output characteristic control unit controlling the constant current supply unit such that the constant current flows in a direction in which the rich detection by the downstream-side exhaust gas sensor is expedited in a case of transition of the output of the downstream-side exhaust gas sensor to a lean side from a rich side with respect to a stoichiometric air-fuel ratio equivalent output and controlling the constant current supply unit such that the constant current flows in a direction in which the lean detection by the downstream-side exhaust gas sensor is expedited in a case of transition of the output of the downstream-side exhaust gas sensor to the rich side from the lean side with respect to the stoichiometric air-fuel ratio equivalent output.

2. The exhaust gas purification device for an internal combustion engine according to claim 1,
wherein the estimation value correction unit corrects the estimation value of the oxygen storage state in a rich direction in a case where the estimation value of the oxygen storage state is on the lean side with respect to a predetermined determination value when the output of the downstream-side exhaust gas sensor is on the rich side with respect to a predetermined threshold.

3. The exhaust gas purification device for an internal combustion engine according to claim 1,
wherein the estimation value correction unit corrects the estimation value of the oxygen storage state in a lean direction in a case where the estimation value of the oxygen storage state is on the rich side with respect to the predetermined determination value when the output of the downstream-side exhaust gas sensor is on the lean side with respect to the predetermined threshold.

4. The exhaust gas purification device for an internal combustion engine according to claim 1, further comprising:
a neutral control unit controlling the oxygen storage state based on the estimation value of the oxygen storage state such that the oxygen storage state reaches a neutral state.
